(19) United States
(12) Patent Application Publication
(10) Pub. No.: US 2009/0022323 A1
(43) Pub. Date: Jan. 22, 2009

(54) SECRET KEY PREDISTRIBUTION METHOD

(76) Inventors: Jooyoung Lee, Seoul (KR); Daesung Kwon, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/110,414

(22) Filed: Apr. 28, 2008

(30) Foreign Application Priority Data
Jul. 18, 2007 (KR) 10-2007-0071867

(51) Int. Cl. H04L 9/00

(52) U.S. Cl. 380/279

(57) ABSTRACT

A secret key predistribution method is provided. The secret key predistribution method includes the steps of: performing a tree structure establishment process by causing a center to release a tree structure and causing sensor nodes to store the released tree structure; performing a seed key and hashed key generation process by causing the center to select a seed key and extract hashed keys by applying a hash function according to the tree structure; and performing a key predistribution process by causing the center to select key id sequences and causing the sensor nodes to store the selected sequences and corresponding hashed keys. Accordingly, the secret key distribution method can provide excellent resiliency and efficiency in terms of hash computational complexity.

### BACKGROUND OF THE INVENTION

1. Field of the Invention

The present invention relates to a secret key predistribution method, and more particularly, to a secret key predistribution method which calculates hashed information of each sensor node, based on a tree, and allocates it to each sensor node, thereby providing a reduced computation amount, an improved efficiency in message traffic, and an enhanced security for node capture.

2. Description of the Related Art

As sensor networks are widely used, authentication between nodes and key distribution for secure communication became an important issue. Key distribution schemes include an asymmetric key agreement scheme, a trusted authority (TA) based key distribution scheme, and a key predistribution scheme. An asymmetric key agreement scheme has a disadvantage in that it is not suitable in lightweight environment because each sensor node necessarily executes extremely complex computations such as modular exponentiation. In a TA based key distribution scheme such as Kerberos, a whole network might be fatally damaged by capture and attack of a small number of sensor nodes serving as the trusted authority. Therefore, a key establishment using a key predistribution scheme (KPS) is considered as the most potent scheme in sensor node applications.

A Blom scheme is a typical key predistribution scheme in a general network model (R. Blom. An optimal class of symmetric key generation systems. Lecture Notes in Computer Science, 209 (1985), 335-338 (Advances in Cryptology—EUROCRYPT '84). The Blom scheme predistributes keys using a bivariate polynomial or a symmetric matrix, and an arbitrary pair of nodes (users) can compute their secret key. This scheme was generalized to a group key predistribution scheme by Blundo et al. (E. Blundo, A. De Santis, A. Herzberg, S. Kutten, U. Vaccaro and M. Yung. Perfectly-secure key distribution for dynamic conferences. Lecture Notes in Computer Science, 740 (1993), 471-486 (Advances in Cryptology—CRYPTO '92). In another direction of research, a scheme using keys extracted based on a hash chain was proposed by Leighton and Micali in 1993.

A key predistribution scheme specialized in sensor networks was first proposed in Eschenauer and Gligor's paper. (L. Eschenauer and V. D. Gligor. A key-management scheme for distributed sensor networks, In proceedings of the 9th ACM Conference on Computer and Communications Security, 41-47, November 2002). The authors proposed a probabilistic key predistribution scheme for sensor networks, that consists of three phases: key predistribution, direct key establishment, and path key establishment. The Eschenauer-Gligor scheme was generalized to a q-composite scheme. (H. Chan, A. Perrig, and D. Song. Random key predistribution schemes for sensor networks, In IEEE Symposium on Research in Security and Privacy, 197-213, May 2003). Two sensors establish a direct link only when the number of shared keys is greater than q. Liu et al combined the probabilistic scheme with the Blom scheme (D. Liu and P. Ning, establishing pairwise keys in distributed sensor networks, In proceedings of the 10th ACM Conference on Computer and Communications Security, 52-61, October 2003) (W. Du, J. Deng, Y. S. Han, and P. K. Varsheney. A pairwise key pre-distribution scheme for wireless sensor networks. In proceedings of the 10th ACM Conference on Computer and Communications Security, 42-51, October 2003), and M. Ramkumar et al combined it with the Leighton-Micali scheme (M. Ramkumar and N. Memon, An efficient key predistribution scheme for ad hoc network security, IEEE Journal on Selected Areas in Communications, 23, No. 3 (2005), 611-621). Stinson et al studied a deterministic key predistribution scheme for sensor networks (J. Lee and D. R. Stinson. A combinatorial approach to key predistribution for distributed sensor networks. The IEEE Wireless Communications and Networking Conference, CD-ROM, 2005, paper PHY53-06, 6-11, http://www.math.uwaterloo.ca/dstinson/pubs.htlm).

### SUMMARY OF THE INVENTION

Accordingly, the present invention is directed to a secret key predistribution method, which substantially obviates one or more problems due to limitations and disadvantages of the related art.

It is an object of the present invention to provide a secret key predistribution method in which a network center selects k secret seeds, generates k hash trees by repetitively applying a hash function to the respective seeds according to the tree structure, and chooses randomly one hashed key from each hash tree to install with a sensor node. Therefore, when an appropriate tree structure is used, the secret key predistribution method according to the present invention can provide excellent resiliency and reduce hash computational complexity, compared with the conventional chain-based scheme.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a secret key predistribution method, including: establishing a tree structure by causing a center to release a tree structure and causing sensor nodes to store the released tree structure; generating a seed key and hashed keys by causing the center to select a seed key and extracting hashed keys by applying a hash function according to the tree structure; predistributing a key by causing the center to select key id sequences and causing the sensor nodes to store the selected key id sequences and the corresponding hashed keys; and establishing a direct key by causing two sensor nodes to exchange their unique IDs and key id sequences, compute a set of common key ids and compute a pairwise key when the computed set is not an empty set.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a flowchart of a tree-based key predistribution method according to an embodiment of the present invention; and

FIG. 2 illustrates a process of inductively generating a hashed key in a secret seed.

### DETAILED DESCRIPTION OF THE INVENTION

Hereinafter, a secret key predistribution method (a tree-based key predistribution scheme (TKPS)) will be described in detail with reference to the accompanying drawings.

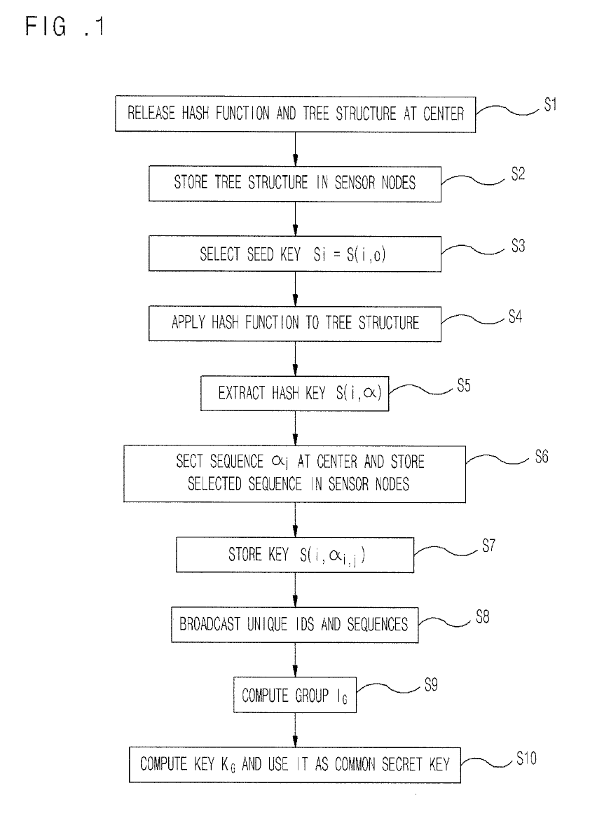

FIG. 1 illustrates a flowchart of a tree-based key predistribution method according to an embodiment of the present invention.

Referring to FIG. 1, the tree-based key predistribution method includes a tree structure establishment step, a seed and hashed key generation step, a key predistribution step, and a direct key establishment step.

In the tree structure establishment step (S1-S2), a center releases a tree structure and each sensor node stores the released tree structure.

In the seed and hash key generation step (S3-S5), the center selects a seed key and extracts a hashed key by applying a hash function according to the tree structure.

In the key predistribution step (S6-S7), when the center selects a key id sequence corresponding to a sensor node, the sensor node stores the selected sequence and the corresponding hashed keys.

In the direct key establishment step (S8-S10), a set is computed by exchanging unique IDs and key id sequences of neighboring sensor nodes. When the computed set is not an empty set, a common secret key of the neighboring sensor nodes is computed. In a key establishment of a plurality of sensor nodes, a set is similarly computed by exchanging unique IDs and key id sequences of the sensor nodes. When the computed set is not an empty set, a group secret key is computed.

### EMBODIMENTS

The tree-based key predistribution method including the tree structure establishment step, the seed and hashed key generation step, the key predistribution step, and the direct key establishment step will be described below in detail.

The center uses a public hash function h:{0,1}^{l}^{₁}^{+l}^{₂}→{0,1}^{l}₁. The hash function h has a unidirectional characteristic that can simply compute an output value when an input value is given, but has difficulty in recovering an input value when an output value is given. In the following process, the sensor nodes are expressed as integers 1, . . . , N for convenience.

A. Tree Structure Establishment Step

1. The center releases the hash function h:{0,1}^{l}^{₁}^{+l}^{₂}→{0,1}^{l}^{₁} and a rooted tree T defined at vertexes {0, . . . , L−1}, where l₁ is a key length for secure symmetric key encryption, and l₂ is a positive integer satisfying l₂≧[log₂max_{νεT}(number of children vertices)].

2. The tree structure T is stored in each sensor node.

B. Seed and Hashed Key Generation Step

1. The center selects a random value sᵢ=s(i,0) of the length l₁ for 1≦i≦k.

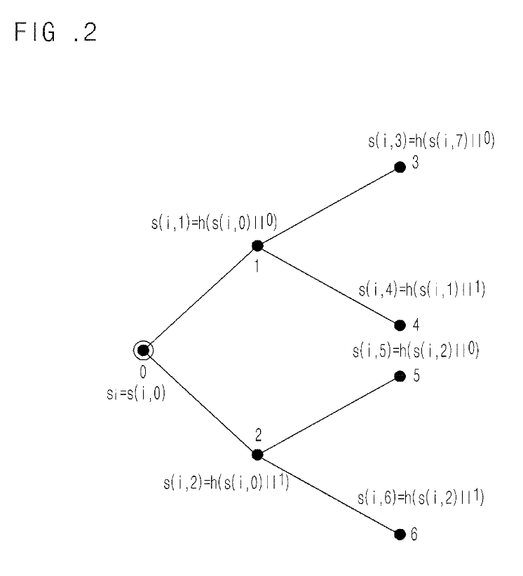

2. A secret value s(i,α) is recursively extracted by applying the hash function, based on the tree T. When α₂ is a b-th child vertex of α₁, s(i,α₂)=h(s(i,α₁)∥b−1) (see FIG. 2)

C. Key Predistribution Step

1. The center selects a key id sequence αⱼ=(α_{1,j}, . . . , α_{b,j})ε{0,L−1}^{k} independent at random for each node j, and stores it as the public information in the node.

2. A secret value s(i,α_{1,j}) for 1≦i≦k is stored in the node j.

D. Direct Key Establishment Step (Common Key of Two Nodes)

1. Two neighboring sensor nodes j₁ and j₂ exchange their unique node IDs and key id sequences αⱼ₁,αⱼ₂ε{0,L−1}^{k}.

2. The sensor nodes j₁ and j₂ can compute a set Iⱼ_{₁}_{,j}_{₂}={1≦i≦k:α_{i,j}_{₁}≦_{T}α_{i,j}_{₂} or α_{i,j}_{₂}≦_{T}α_{i,j}_{₁}}. ≦_{T} is an ordering defined by the tree T. When the vertex α is an ancestor of the vertex β, α≦_{T}β.

if Iⱼ_{₁}_{,j}_{₂}≠φ, the sensor nodes j₁ and j₂ compute a key

$${K}_{{j}_{1} , {j}_{2}} = {⊕}_{i ∈ {I}_{{j}_{1} , {j}_{2}}} s ( i , max ( {α}_{i , {j}_{1}} , {α}_{i , {j}_{2}} ) )$$

and use it as their common secret key ⊕ represents a bitwise XOR operator.

When a group G={j₁, . . . , j_{g}} that consists of g(>2) number of sensor nodes establishes a direct key, the step D is replaced with a following step D′.

D′. Direct Key Establishment Step (Group Key of Multiple Nodes)

1. The respective nodes of the sensor node group G={j₁, . . . , j_{g}} broadcast their unique node IDs and public key id sequences, and compute I_{G}={1≦i≦k:∃j(i)εG,∀jεG,α_{i,j}≦_{T}α_{j,j(i)}}.

2. if I_{G}≠φ, the sensor nodes of the group compute a key

$${K}_{G} = {⊕}_{i ∈ {I}_{G}} s ( i , {α}_{i , {j}^{*} ( i )} )$$

and use it as their common secret key.

According to the present invention, a pairwise key of nodes or a group key of a node group can be established by using the key predistribution scheme for sensor networks. If the secret key predistribution method is based on an optimal tree structure, it requires a small hash computational complexity, compared with the Leighton-Micali scheme. Furthermore, the secret key predistribution method according to the present invention can provide an excellent resiliency against random node capture attack, compared with other existing schemes.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A secret key predistribution method, comprising:
establishing a tree structure by causing a center to release a tree structure and causing sensor nodes to store the released tree structure;
generating a seed key and hashed keys by causing the center to select a seed key and extracting hashed keys by applying a hash function according to the tree structure;
predistributing a key by causing the center to select key id sequences and causing the sensor nodes to store the selected key id sequences and the corresponding hashed keys; and
establishing a direct key by causing two sensor nodes to exchange their unique IDs and key id sequences, compute a set of common key ids and compute a pairwise key when the computed set is not an empty set.
